(19) United States
(12) Patent Application Publication
(10) Pub. No.: US 2011/0047755 A1
(43) Pub. Date: Mar. 3, 2011

(54) HINGE

(75) Inventor: JUNG-BIN CHANG, Tu-Cheng (TW)

(73) Assignee: HON HAI PRECISION INDUSTRY CO., LTD., Tu-Cheng (TW)

(21) Appl. No.: 12/580,274

(22) Filed: Oct. 16, 2009

(30) Foreign Application Priority Data
Sep. 2, 2009 (CN) 200920309517.3

(51) Int. Cl. E05D 11/10

(52) U.S. Cl. 16/353

(57) ABSTRACT

A hinge is disclosed. The hinge includes a bracket defining a slot, a rack rotatable relative to the bracket, a stopping member foxed to the rack, and a limiting member rotatably mounted to the rack. The stopping member includes a stopping portion. The limiting member includes a limiting portion. When the rack rotates with respect to the bracket, the stopping portion of the stopping member engages with the limiting portion of the limiting member to slide in the slot of the bracket, until the limiting portion of the limiting member engages with one of the engaging walls of the slot to limit rotation of the rack. A length of the slot of the bracket is adjustable to control a rotating angle of the rack to be 360 or more degrees.

### CROSS-REFERENCE TO RELATED APPLICATION

The relevant subject matter is disclosed in a co-pending U.S. patent application Ser. No. (Attorney Docket No. US27860) filed on the same date and entitled “HINGE,” which is assigned to the same assignee as this patent application.

### BACKGROUND

1. Technical Field

The disclosure relates to hinges, and particularly to a bidirectional hinge.

2. Description of Related Art

A collapsible device, such as a notebook computer, or a clamshell mobile phone, generally including a main body and a cover, often uses a hinge to interconnect the main body and the cover. The hinge allows the cover to be rotatable with respect to the main body, and to be folded with the main body for saving space.

A bidirectional hinge normally includes a horizontal pivot structure and an upright pivot structure. The horizontal pivot structure allows the cover to be rotatable with respect to the main body along a horizontal axis. The upright pivot structure allows the cover to be rotatable with respect to the main body along an upright axis. However, the traditional upright pivot structure does not allow the cover to be rotatable with respect to the main body along an upright axis in a 360 degree range.

### BRIEF DESCRIPTION OF THE DRAWINGS

FIG. 1 is an exploded, isometric view of an exemplary embodiment of a hinge.

FIG. 2 is an inverted view of FIG. 1.

FIG. 3 is an assembled, isometric view of the hinge of FIG. 1.

FIG. 4 is an assembled, isometric view of the hinge of FIG. 2.

FIGS. 5 and 6 are plan views of partial elements of the hinge of FIG. 1, but showing different using states.

### DETAILED DESCRIPTION

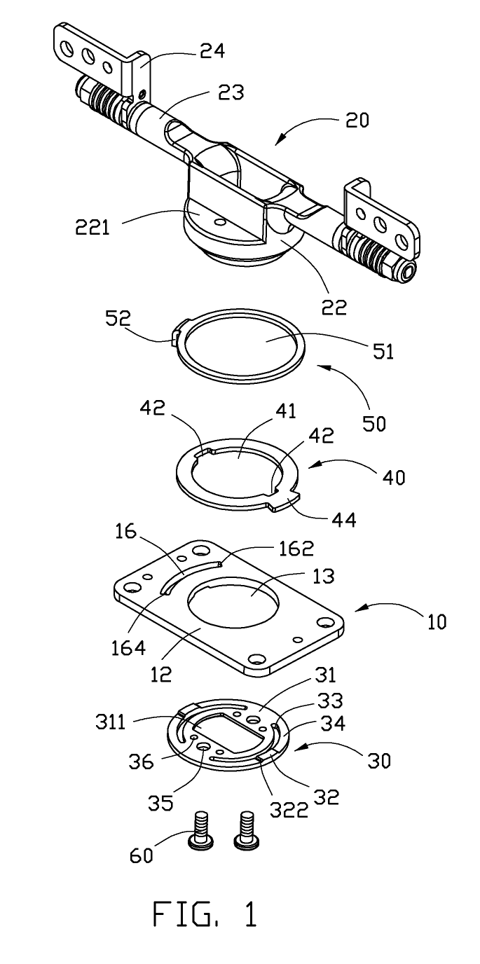

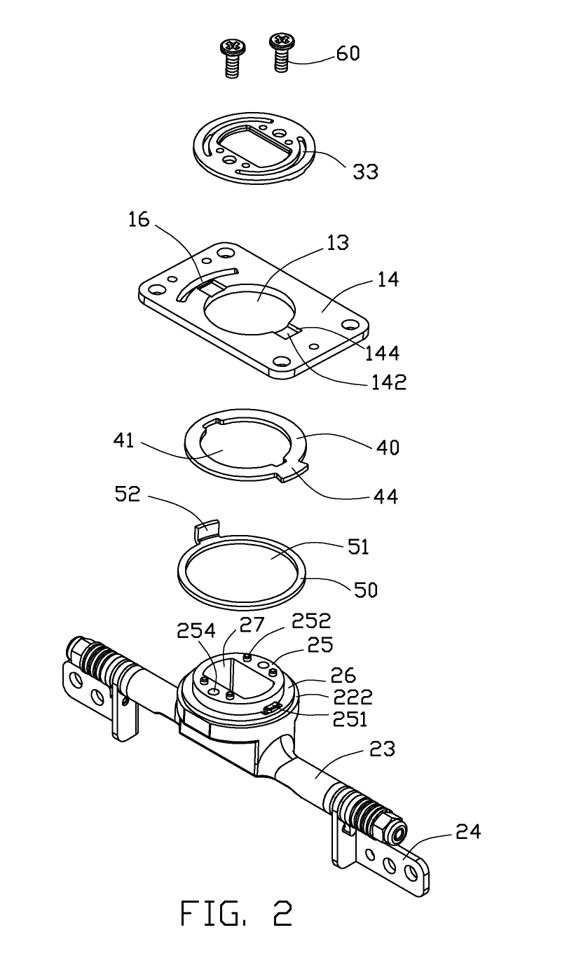

Referring to FIGS. 1 and 2, an exemplary embodiment of a hinge is adapted to be mounted to a collapsible device (not shown), such as a notebook computer or a clamshell mobile phone, which includes two parts rotatably connected to each other via the hinge. The hinge includes a bracket 10, a rack 20, a mounting member 30, a stopping member 40, a limiting member 50, and two fasteners 60. In this embodiment, the fasteners 60 are bolts.

The bracket 10 is a plate, and includes a first side 12 and a second side 14 opposite to the first side 12. The bracket 10 defines four mounting holes (not labeled) in four corners of the bracket 10, for mounting the bracket 10 to one part of the collapsible device. The bracket 10 further defines a pivot hole 13 in a center of the bracket 10. An arc-shaped slot 16 is defined in the bracket 10 in the vicinity of the pivot hole 13. Two engaging walls 162, 164 are formed at opposite ends of the slot 16. The second side 14 defines two opposite depressed portions 142 in communication with the pivot hole 13. Each depressed portion 142 forms two inclined surfaces 144 connected to opposite ends of a bottom of the depressed portion 142 and the second side 14, respectively.

The rack 20 is generally T-shaped, and includes a main body 22, and two opposite shafts 23 extending from a first side 221 of the main body 22. A protrusion is formed on a second side 222 opposite to the first side 221 of the main body 22. A mounting piece 24 is mounted to each shaft 23. Each of the mounting pieces 24 is able to be fixed to the other part of the collapsible device. The protrusion of the second side 222 includes a ring portion 26 and a pivoting portion 25 protruding from a center of the ring portion 26. A cable hole 27 is defined in a center of an end surface of the pivoting portion 25. The ring portion 26 forms two tabs 251 jointing with a circumference of the pivoting portion 25. A plurality of posts 252 extend from the circumference of the pivoting portion 25 beside the cable hole. Two mounting holes 254 are defined in the end surface of the pivoting portion 25 beside the cable hole.

The mounting member 30 is generally coin-shaped. The mounting member 30 defines a through hole 311 having a double-D shape in a center of the mounting member 30, and two arc-shaped through slots 33 around the through hole. A resilient portion 34 is formed on the mounting member 30, opposite to the through hole 311 relative to each through slot 33. A locating block 32 protrudes from on each resilient portion 34 at a side 31 of the locating block 32. Two slanting surfaces 322 are formed at opposite ends of each locating block 32, smoothly transition to the side 31. Two holes 35 and a plurality of limiting holes 36 are defined in the mounting member 30 around the through hole 311.

The stopping member 40 is generally ring-shaped. The stopping member 40 defines a round through hole 41 in a center of the stopping member 40. Two opposite cutouts 42 are defined in the stopping member 40 and communicating with the through hole 41. A stopping portion 44 extends outward from an edge of the stopping member 40.

The limiting member 50 is generally ring-shaped. The limiting member 50 defines a round through hole 51 in a center of the limiting member 50. A limiting portion 52 extends from an edge of the limiting member 50, extending along an axis of the round through hole 51.

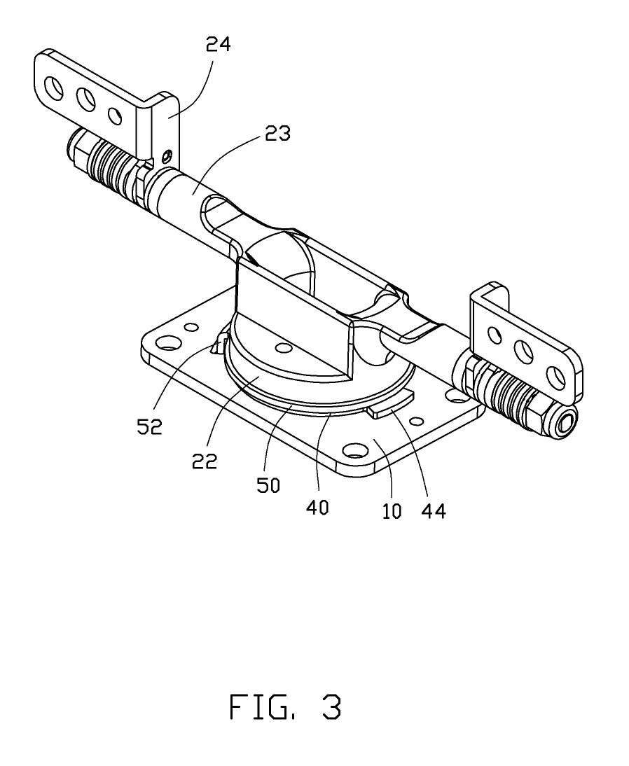

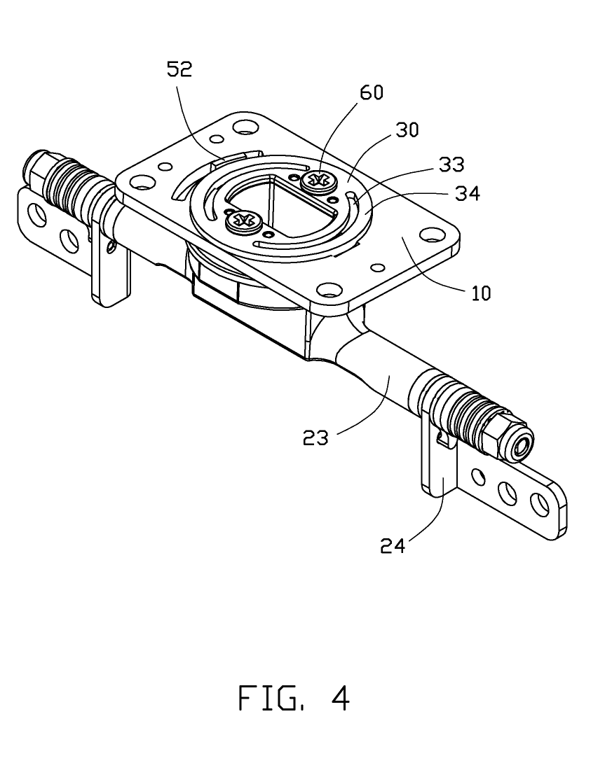

Referring to FIGS. 3 and 4, in assembly, the limiting member 50 is set around the ring portion 26 of the rack 20. The stopping member 40 is set around the pivoting portion 25 of the rack 20. The tabs 251 of the pivoting portion 25 engage in the cutouts 42 of the stopping member 40, respectively. The bracket 10 is set around the pivoting portion 25 of the rack 20 via the pivoting hole 13, with the first side 12 facing the rack 20. The mounting member 30 is in tight contact with the second side 14 of the bracket 10. The plurality of posts 252 of the pivoting portion 25 engage in the limiting holes 36 of the mounting member 30, respectively. The limiting portion 52 of the limiting member 50 movably engages in the slot 16 of the bracket 10. The fasteners 60 extend through the holes 35 of the mounting member 30 to screw into the mounting holes 254 of the rack 20 respectively. The resilient portions 34 of the mounting member 30 are deformed by the bracket 10 to supply force to press the mounting member 30 to the bracket 10.

In use, when one part of the collapsible device rotates with respect to the other part of the collapsible device along an upright axis, the rack 20 rotates with respect to the bracket 10. The pivoting portion 25 of the rack 20 rotates in the pivot hole 13 of the bracket 10 to drive the mounting member 30 and the stopping member 40 to rotate with respect to the bracket 10. The locating blocks 32 of the mounting member 30 are capable of engaging in the depressed portions 142 of the bracket 10, respectively, for locating the mounting member 30 relative to the bracket 10. The locating blocks 32 of the mounting member 30 can be releasable from the depressed portions 142 of the bracket 10, respectively, via the inclined surfaces 144 pressing against the slanting surfaces 322 for releasing the locating blocks 32 from the depressed portions 142 of the bracket 10.

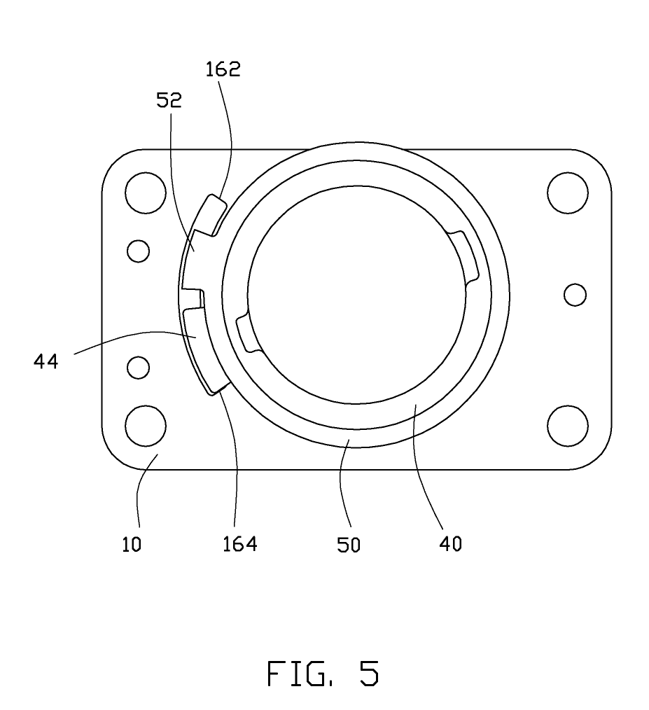

Referring to FIG. 5, when the rack 20 rotates with respect to the bracket 10 clockwise at an angle, the stopping portion 44 of the stopping member 40 engages with the limiting portion 52 of the limiting member 50, to slide the limiting portion 52 of the limiting member 50 in the slot 16 of the bracket 10, until the limiting portion 52 of the limiting member 50 engages with the engaging wall 162 of the slot 16 to limit the rack 20.

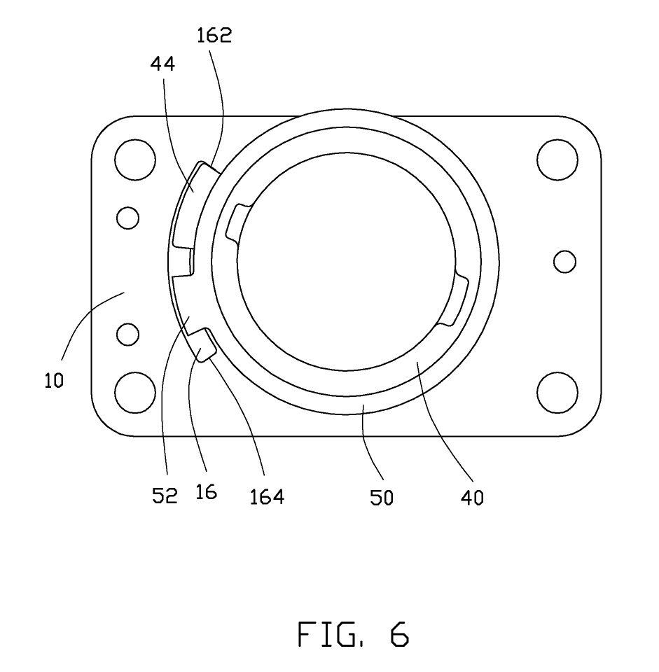

Referring to FIG. 6, when the rack 20 rotates with respect to the bracket 10 counterclockwise at an angle, the stopping portion 44 of the stopping member 40 engages with the limiting portion 52 of the limiting member 50 to slide the limiting portion 52 of the limiting member 50 in the slot 16 of the bracket 10, until the limiting portion 52 of the limiting member 50 engages with the engaging wall 164 of the slot 16 to limit the rack 20.

In this embodiment, a length of the slot 16 is adjustable to control a rotating angle of the rack 20 to be 360 or more degrees.

While several embodiments have been disclosed, it is understood that any element disclosed in any one embodiment is easily adapted to other embodiments. It is also to be understood, however, that even though numerous characteristics and advantages of the disclosure have been set forth in the foregoing description, together with details of the structure and function of the invention, the disclosure is illustrative only, and changes may be made in details, especially in matters of shape, size, and arrangement of parts within the principles of the invention to the full extent indicated by the broad general meaning of the terms in which the appended claims are expressed.

1. A hinge, comprising:
a bracket defining a slot with two engaging walls;
a rack comprising a pivoting portion, the bracket rotatably set around the pivoting portion of the rack;
a stopping member fixed to the rack, the stopping member comprising a stopping portion;
a limiting member rotatably set around the pivoting portion of the rack, the limiting member comprising a limiting portion engaged in the slot; and
a mounting member attached to the rack, wherein the bracket is sandwiched between the mounting member and the pivoting portion of the rack, the mounting member contacts with a side of the bracket, two arc-shaped through slots extend through the mounting member and two resilient portions are respectively formed at outside edges of the two slots, a locating block extends from each resilient portion for engaging with the side of the bracket;
wherein when the rack rotates with respect to the bracket, the stopping portion of the stopping member engages with the limiting portion of the limiting member to slide the limiting portion of the limiting member in the slot of the bracket, until the limiting portion of the limiting member engages with one of the engaging walls of the slot to limit rotation of the rack.

2. The hinge of claim 1, wherein the bracket defines a pivoting hole for rotatably setting around the pivoting portion of the rack, the rack comprises a ring portion surrounding the pivoting portion and with a larger diameter than that of the pivoting portion, the limiting member is rotatably set around the ring portion.

3. The hinge of claim 1, wherein the mounting member is in tight contact with the side of the bracket and defines a through hole, the pivoting portion of the rack defines a mounting hole, a fastener extends through the through hole of the mounting member to fasten into the mounting hole of the pivoting portion of the rack.

4. The hinge of claim 1, wherein the stopping member defines a round through hole for setting around the pivoting portion of the rack, two cutouts are defined in the stopping member communicating with the round through hole, the pivoting portion of the rack comprises two tabs for engaging in the cutouts of the stopping member.

5. The hinge of claim 1, wherein the mounting member defines a plurality of limiting holes, a plurality of posts extend on the pivoting portion for engaging in the plurality of limiting holes, respectively.

6. (canceled)

7. The hinge of claim 1, wherein two depressed portions are defined in the side of the bracket, the locating blocks of the mounting member are engagable in the depressed portions of the bracket, respectively, for locating the rack relative to the bracket

8. The hinge of claim 7, wherein each depressed portion forms two inclined surfaces at opposite ends, each locating block forms two slanting surfaces at opposite ends, the locating blocks of the mounting member are operable to be released from the depressed portions of the bracket, respectively, via the inclined surfaces pressing against the slanting surfaces.

9. The hinge of claim 1, wherein the mounting member defines a through hole in a center of the mounting member, and the two arc-shaped through slots opposite to each other and are around the through hole.

10. A bidirectional hinge, comprising:
a bracket defining a slot with two engaging walls;
a rack rotatable relative to the bracket, the rack comprising a main body, and two shaft extending from a first side of the main body opposite to each other, a mounting piece being set around each shaft;
a stopping member fixed to the rack, the stopping member comprising a stopping portion;
a limiting member rotatably mounted to the rack, the limiting member comprising a limiting portion engaged in the slot;
a mounting member contacted with a side of the bracket, opposite to the rack, wherein the mounting member defines two arc-shaped through slots and forms two resilient portions each between a corresponding through slot and the edge of the mounting member at same time, a locating block extends on each resilient portion for engaging with the bracket; and
a fastener extending through the mounting member to fasten to the rack;
wherein when the rack rotates with respect to the bracket, the stopping portion of the stopping member engages with the limiting portion of the limiting member, to slide the limiting portion of the limiting member in the slot of the bracket, until the limiting portion of the limiting member engages with one of the engaging walls of the slot to limit rotation of the rack.

11. The bidirectional hinge of claim 10, wherein the bracket defines a pivoting hole, the rack comprising a ring portion and a pivoting portion facing to the bracket, the limiting member is rotatably set around the ring portion, the stopping member is set around the pivoting portion, the pivoting portion rotatably engages in the pivoting hole of the bracket.

12. The bidirectional hinge of claim 11, wherein the pivoting portion of the rack defines a mounting hole, the fastener extends through the mounting member to screw in the mounting hole of the pivoting portion of the rack

13. The bidirectional hinge of claim 11, wherein the stopping member defines a round through hole for setting around the pivoting portion of the rack, two cutouts are defined in the stopping member communicating with the round through hole, the pivoting portion of the rack comprising two tabs for engaging in the cutouts of the stopping member.

14. The bidirectional hinge of claim 12, wherein the mounting member defines a plurality of limiting holes, a plurality of posts extend on the pivoting portion for engaging in the plurality of limiting holes, respectively.

15. (canceled)

16. The bidirectional hinge of claim 10, wherein two depressed portions are defined in the bracket, the locating blocks of the mounting member are engagable in the depressed portions of the bracket, respectively, for locating the rack relative to the bracket.

17. The bidirectional hinge of claim 16, wherein each depressed portion forms two inclined surfaces at opposite ends, each locating block forms two slanting surfaces at opposite ends, the locating blocks of the mounting member are operable to be released from the depressed portions of the bracket, respectively, via the inclined surfaces mating the slanting surfaces.

18. The bidirectional hinge of claim 10, wherein the mounting member defines a through hole in a center of the mounting member, and the through slots are around the through hole.
